(19) United States
(12) Patent Application Publication
(10) Pub. No.: US 2009/0289926 A1
(43) Pub. Date: Nov. 26, 2009

(54) PLASMA DISPLAY DEVICE

(75) Inventors: Shinsuke TANAKA, Fujisawa (JP); Shinichi Miyaguchi, Ichikawa (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/276,691

(22) Filed: Nov. 24, 2008

(30) Foreign Application Priority Data
Feb. 1, 2008 (JP) 2008-22698

(51) Int. Cl. G06F 3/038

(52) U.S. Cl. 345/204; 345/60

(57) ABSTRACT

A plasma display device includes: a display panel which has a plurality of X and Y display electrodes and a plurality of address electrodes crossing the X and Y display electrodes; an electrode drive circuit which drives the X and Y display electrodes and address electrodes; and a drive circuit which control the electrode drive circuit. The drive control circuit performs an address drive control for selectively turning cells ON in each subfield, sustain drive control for generating sustain discharge in the ON cells, and reset drive control for resetting charges on the electrodes by applying slope pulse voltage on the Y display electrodes. The drive control circuit also performs reset drive control corresponding to the sustain discharge count.

### CROSS-REFERENCE TO RELATED APPLICATIONS

This application is based upon and claims the benefit of priority of the prior Japanese Patent Application No. 2008-22698, filed on Feb. 1, 2008, the entire contents of which are incorporated herein by reference.

### BACKGROUND OF THE INVENTION

The present invention relates to a plasma display device, and more particularly to a plasma display device in which the reset problem is improved.

Plasma display devices are widely used as large screen slim TVs. Recently plasma display devices are receiving particular attention as full high vision supported slim TVs.

Driving of the panel of a plasma display device includes: a reset period when the wall charge state of the cells is reset, an address period when display electrodes are scanned and the display image is written in the cells, and a sustain period when a sustain discharge is generated for a plurality of times in the cells written in the address period, and high brightness emission is performed. The field period for displaying one image consists of a plurality of subfields, and each subfield has a reset period, address period and sustain period. In one field period, multi-grayscale display is performed by making the sustain discharge count in the sustain period of each subfield different, and combining the subfields which turn ON.

For a plasma display device, it has been proposed that the wall charge state of the cells which are turned ON is reset in the reset period, and an slope pulse (or ramp waveform pulse) is applied to the display electrodes to generate a micro-discharge so as to adjust the wall charge amount. Examples are disclosed in Japanese Patent Application Laid-Open No. 2003-15602, No. 2003-157043, No. 2003-302931, No. 2004-4513 and No. 2000-267625.

These patent documents disclose that a positive polarity slope pulse is applied and then a negative polarity slope pulse is applied to a Y electrode corresponding to a scan electrode, out of the display electrodes, during the reset period.

As mentioned above, in the reset period, a positive polarity slope pulse is applied between the Y electrode and X electrode constituting the display electrode to reset the wall charge state on the X and Y electrodes and address electrodes on the cell, and a negative polarity slope pulse is applied between the Y electrode and X electrode so as to adjust the wall charge amount to an optimum amount. By making the wall charge amount on each electrode to be an optimum amount, the address discharge can be generated between the address electrode and Y electrode and discharge can also be generated between the X and Y electrodes, only in the cells to be turned ON, in the subsequent address period. In the sustain period, a sustain pulse is applied between the X and Y electrodes for a predetermined number of times, then a sustain discharge is generated in the ON cells, where the wall charges are generated on the X and Y electrodes by an address discharge. Therefore the amount of wall charge on each electrode must be optimum by generating an ideal discharge in the reset period.

However, in the plasma display device, the sustain discharge count is different in each subfield, and the sustain discharge count is variable-controlled in order to control the power consumption due to the change in the display load rate. Therefore in each subfield, the state of wall charges at the completion of the sustain period is not always the same in each cell. Particularly in a subfield of which sustain discharge count is low, the sustain period ends in a state where the wall charge state of the cell is unstable. In this way, the wall charge state of the cells at the completion of the sustain period differs depending on the subfield, so if a common drive voltage waveform is used for each electrode during the reset period, an ideal reset discharge may be generated in some subfields, but a reset failure may be generated in other subfields.

### SUMMARY OF THE INVENTION

With the foregoing in view, it is an object of the present invention to provide a plasma display device which performs desirable reset drive control.

According to a first aspect, a plasma display device, comprises: a display panel having a plurality of first and second display electrodes and a plurality of address electrodes crossing the first and second display electrodes; an electrode drive circuit which drives the first and second display electrodes and address electrodes; and a drive control circuit which controls the electrode drive circuit, wherein

the drive control circuit performs an address drive control for selectively turning ON cells in each subfield, sustain drive control for generating sustain discharge in the ON cells, and reset drive control for resetting charges on the electrodes by applying slope pulse voltage on the first display electrodes, and

in the reset drive control in a first subfield in which a sustain discharge count is a first count, the drive control circuit sets a voltage between the first and second electrodes higher, or sets a voltage between the first and address electrodes lower, than a second subfield of which the sustain discharge count is a second count, which is higher than the first count.

In the case of the first count, of which the sustain discharge count is low, charges remain on the address electrode when sustain driving ends, so the voltage between the first and second electrodes is controlled to be relatively higher than the voltage between the first and address electrodes, whereby a weak discharge between the first and second electrodes can be generated with certainty.

In the first aspect, it is preferable that in the reset drive control for a third subfield, of which the sustain discharge count is a third count, which is higher than the second count, the drive control circuit sets the voltage between the first and second electrodes to be higher, or sets the voltage between the first and address electrodes to be higher than the second subfield.

In the case of the third count of which sustain discharge count is relatively high, the charges on the first and second electrodes leak during reset driving, so it is preferable to increase the charge on both the first and second electrodes by increasing the voltage between the first and second electrodes. Also in the case of the third count, the charge amount on the address electrode is extremely low, so it is preferable to increase the voltage between the first and address electrodes, so as to prompt the generation of a reset discharge between the first and address electrodes.

In the first aspect, it is preferable that in a third subfield, of which the sustain discharge count is a third count, which is higher than the second count, the drive control circuit sets a time between the end of sustain drive control and the start of reset drive control to be longer than the second subfield.

In the case of the third count, of which sustain discharge count is relatively high, discharge easily occurs and charges on the first and second electrodes leak during reset driving, so the leak of charges can be suppressed by increasing the time between the end of sustain drive control and the start of reset drive control.

In the first aspect, it is preferable that in the reset drive control for a third subfield, of which sustain discharge count is a third count, which is higher than the second count, the drive control circuit sets the voltage of the last sustain pulse higher than the second subfield.

In the case of the third count, of which sustain discharge count is relatively high, the charges on the first and second electrodes leak during reset driving, so it is preferable to increase the charge amount on the first and second electrodes by increasing the last sustain pulse voltage.

In the first aspect, it is preferable that in the reset drive control for the first subfield, if the last sustain pulse is a first voltage, the drive control circuit sets the voltage between the first and address electrode higher, or sets the voltage between the first and second electrodes lower than the case of the last sustain pulse being a second voltage, which is lower than the first voltage.

In the first aspect, it is preferable that in the reset drive control for the second subfield, if the last sustain pulse is a first voltage, the drive control circuit sets the voltage between the first and address electrodes higher, or the voltage between the first and second electrodes lower than the case of the last sustain pulse being a second voltage which is lower than the first voltage.

According to a second aspect, a plasma display device, comprises: display panel having a plurality of first and second display electrodes and a plurality of address electrodes crossing the first and second display electrodes; an electrode drive circuit which drives the first and second display electrodes and address electrodes; and a drive control circuit which controls the electrode drive circuit, wherein

the drive control circuit performs an address drive control for selectively turning cells ON in each subfield, sustain drive control for generating sustain discharge in the ON cells, and reset drive control for resetting charges on the electrodes by applying slope pulse voltage on the first display electrodes,

the drive control circuit further comprises a control data ROM which stores a plurality of subfield drive control data having data of the address drive control, sustain drive control and reset drive control which corresponds to the sustain drive control, for each of a plurality of types of sustain drive control, and

the drive control circuit performs the subfield drive control based on subfield drive control data which has sustain drive control corresponding to an emission brightness of each subfield.

According to the second aspect, the drive control circuit can perform subfield drive control easily. Or the data volume of the subfield drive control can be decreased.

In the second aspect, it is preferable that the drive control circuit performs drive control of different subfields according to the display load ratio based on the same subfield drive control data.

According to the above invention, desirable reset drive control can be performed corresponding to the sustain discharge count.

### BRIEF DESCRIPTION OF THE DRAWINGS

FIG. 1 is a diagram depicting a configuration of a panel of a plasma display device according to the present embodiment.

FIG. 2 is a diagram showing cross-sectional views of the panel in FIG. 1.

FIG. 3 is a block diagram depicting an electrode drive circuit of the plasma display device according to the present embodiment.

FIG. 4 is a diagram depicting the panel driving of the plasma display device according to the present embodiment.

FIG. 5 is a diagram depicting a drive voltage waveform of a subfield according to the present embodiment.

FIG. 6 are diagrams depicting the wall charge state on the three electrodes corresponding to the drive voltage waveform in FIG. 5.

FIG. 7 are diagrams depicting the wall charge states on three electrodes in the sustain period.

FIG. 8 is a diagram showing an example of improving the reset drive voltage waveform according to the present embodiment.

FIG. 9 is a diagram showing reset drive voltage waveforms of the basic countermeasures (A-1) and (B-1) according to the present embodiment.

FIGS. 10 and 11 are diagrams showing the fine adjustment (B-2) of the reset drive voltage waveform in the case when (B) the sustain discharge count is relatively low, is which is a second count (e.g. 20>Nsus≧10).

FIG. 12 and FIG. 13 are diagrams showing the fine adjustment (A-2) of the reset drive voltage waveform in the case when (A) the sustain discharge count is extremely low, which is a first count (e.g. Nsus=0 to 3).

FIG. 14, FIG. 15 and FIG. 16 are diagrams showing the basic countermeasure (C-1) of the reset drive voltage waveform in the case when (C) the sustain discharge count is relatively high, which is a third count (e.g. Nsus≧20).

FIG. 17 is a diagram depicting the control circuit to drive the panel, the Y electrode drive circuit and the X electrode drive circuit according to the present embodiment.

FIG. 18 is a diagram showing the relationship between the display load ratio and control data of the subfield according to the present embodiment.

FIG. 19 is a diagram depicting an example of another drive voltage waveform according to the present embodiment.

### DESCRIPTION OF THE PREFERRED EMBODIMENTS

Embodiments of the present invention will now be described with reference to the drawings. The technical scope of the present invention, however, is not limited to these embodiments, but extend to matters stated in Claims and equivalents thereof.

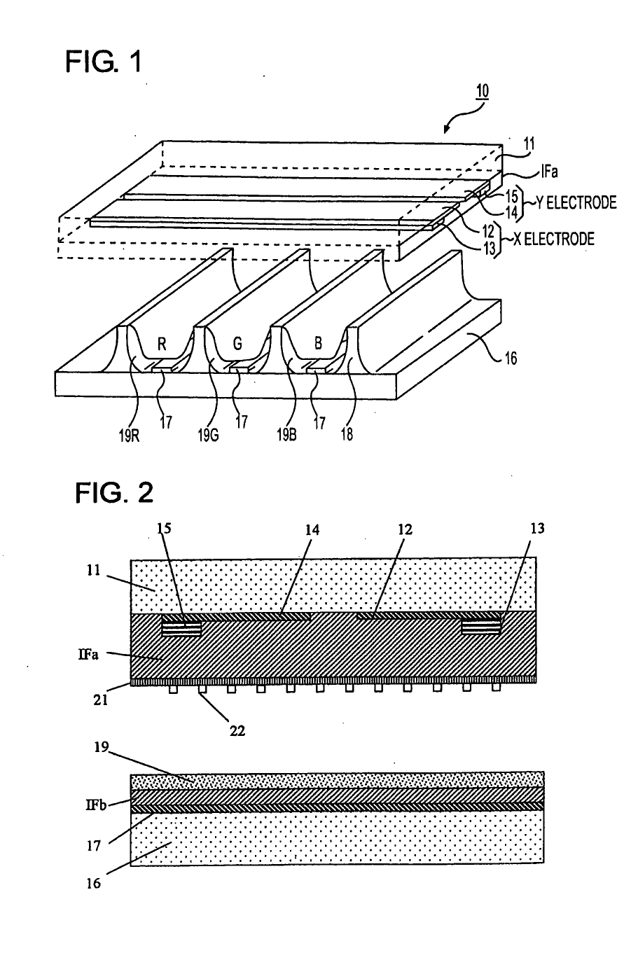

FIG. 1 is a diagram depicting a configuration of a panel of a plasma display device according to the present embodiment. The plasma display panel 10 is comprised of a front substrate 11 and a back substrate 16, which face each other with a discharge space there between. On the front substrate 11, a plurality of pairs of an X electrode, which is comprised of a transparent electrode 12 and a metal bus electrode 13 disposed thereon, and a Y electrode, which is comprised of a transparent electrode 14 and a metal bus electrode 15 disposed thereon, are arranged, and these X and Y electrodes are coated by a dielectric layer IFa. A pair of X and Y electrodes constitute a pair of display electrodes.

On the back substrate 16, a plurality of address electrodes 17, ribs 18 disposed between the address electrodes 17, and fluorescent layers 19R, 19G and 19B, which are formed on the address electrodes 17 and ribs 18, are disposed. The fluorescent layers 19R, 19G and 19B are excited by ultraviolet rays, which are generated when discharge occurs in the discharge space, and emit red, green and blue lights respectively. These emissions transmit through the transparent electrodes 12 and 14 of the front substrate 11, and emit to the front face side.

In FIG. 1, the ribs 18 are formed in the stripes along the address electrodes, but may be formed in a lattice shape so as to enclose the cell areas respectively.

FIG. 2 shows cross-sectional views of the panel in FIG. 1. These are cross-sections along the address electrode 17, and are denoted with the same reference numbers as FIG. 1. In other words, on the front substrate 11, an X electrode comprised of the transparent electrode 12 and metal bus electrode 13, a Y electrode comprised of the transparent electrode 14 and the metal bus electrode 15, and a dielectric layer IFa which coats thereon, are formed, and on the dielectric layer IFa, a protective film 21 made from MgO, and MgO particles 22, which are mono-crystals, are formed. MgO of the protective film 21 is a poly-crystal formed by a deposition method or sputtering method, whereas an MgO particle 22 is a mono-crystal.

On the back substrate 16, the address electrode 17, the dielectric layer IFb which coats thereon, and the fluorescent substrate 19 are formed. The ribs 18 are not shown in FIG. 2.

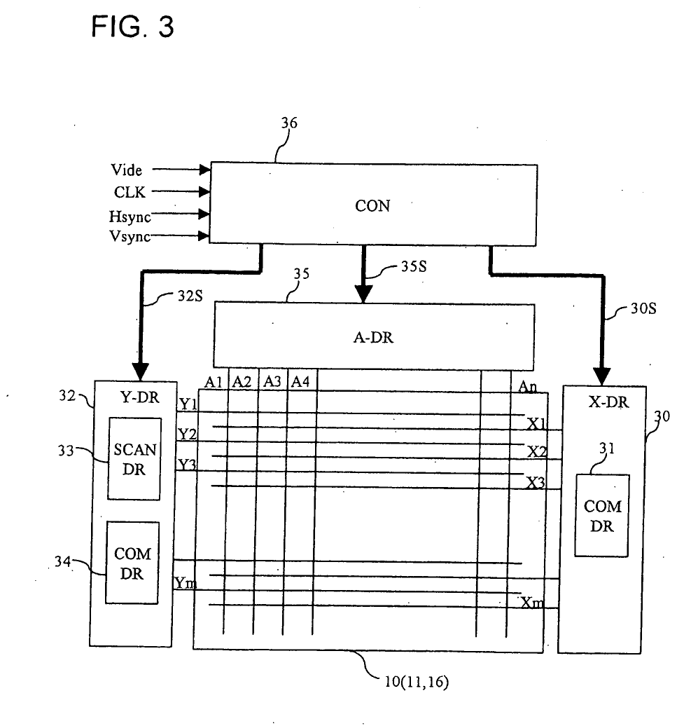

FIG. 3 is a block diagram depicting an electrode drive circuit of the plasma display device according to the present embodiment. In FIG. 3, the panel 10 is shown in a state where the front substrate 11 and the back substrate 16 overlap, and X electrodes X1 to Xm and Y electrodes Y1 to Ym, which extend in the horizontal direction, are alternately disposed, and the address electrodes A1 to An are disposed in the vertical direction.

The electrode drive circuit has an X electrode drive circuit 30 for driving the X electrodes, a Y electrode drive circuit 32 for driving the Y electrodes, an address electrode drive circuit 35 for driving the address electrodes, and a control circuit 36 for controlling the drive operation of each drive circuit by supplying control signals to these drive circuits 30, 32 and 35. The X electrode drive circuit 30 has an X side common drive circuit 31, which applies a common drive pulse to all the X electrodes, and the X side common drive circuit 31 applies a reset pulse, an address voltage and a sustain pulse to the X electrodes. The Y electrode drive circuit 32 has a scanning drive circuit 33 which sequentially applies a scan pulse to the Y electrodes Y1 to Ym, and Y side common drive circuit 34 which applies a reset pulse and a sustain pulse to the Y electrodes.

The control circuit 36 inputs a horizontal synchronization signal Hsync, vertical synchronization signal Vsync, synchronization clock CLK, and analog or digital image signal Video, and supplies drive control signals 30S, 32S and 35S required for driving the panel 10 to the drive circuit 30, 32 and 35 respectively. The control signal 35S, to the address electrode drive circuit, includes the display data generated for each subfield corresponding to the image signal.

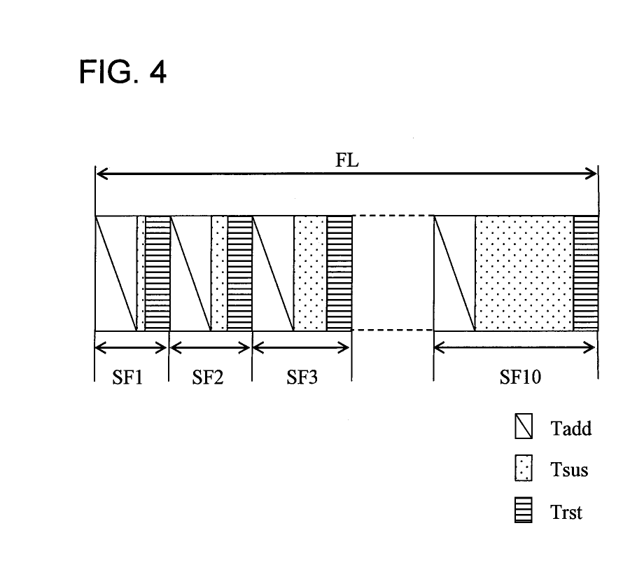

FIG. 4 is a diagram depicting the panel driving of the plasma display device according to the present embodiment. In panel driving, one field FL has a plurality of (e.g. 10) subfields SF1 to SF10, and each subfield SF1 to SF10 has an address period Tadd, sustain period Tsus and reset period Trst. In the case of progressive driving, in which one frame image is displayed by one vertical scanning, the field FL and a frame are the same. Whereas in the case of an interlace driving in which one frame image is displayed by double vertical scanning, two fields FL, correspond to one frame. In any case, one field FL, corresponding to a vertical synchronization period, which is demarcated by the vertical synchronization signal Vsync, is a period for displaying one image on the panel.

In the present embodiment, each subfield is configured by an address period Tadd, sustain period Tsus and reset period Trst, and the reset drive voltage waveform in the reset period in each subfield is controlled to be optimum according to the sustain discharge count, the voltage value and waveform of the sustain pulse in the sustain period in the preceding sustain period. Thereby the reset drive voltage waveform can be set and fixed, corresponding to the sustain control in the sustain period in that subfield, and an ideal reset discharge can be generated corresponding to the sustain control. As a result, the generation of a reset failure can be suppressed or eliminated.

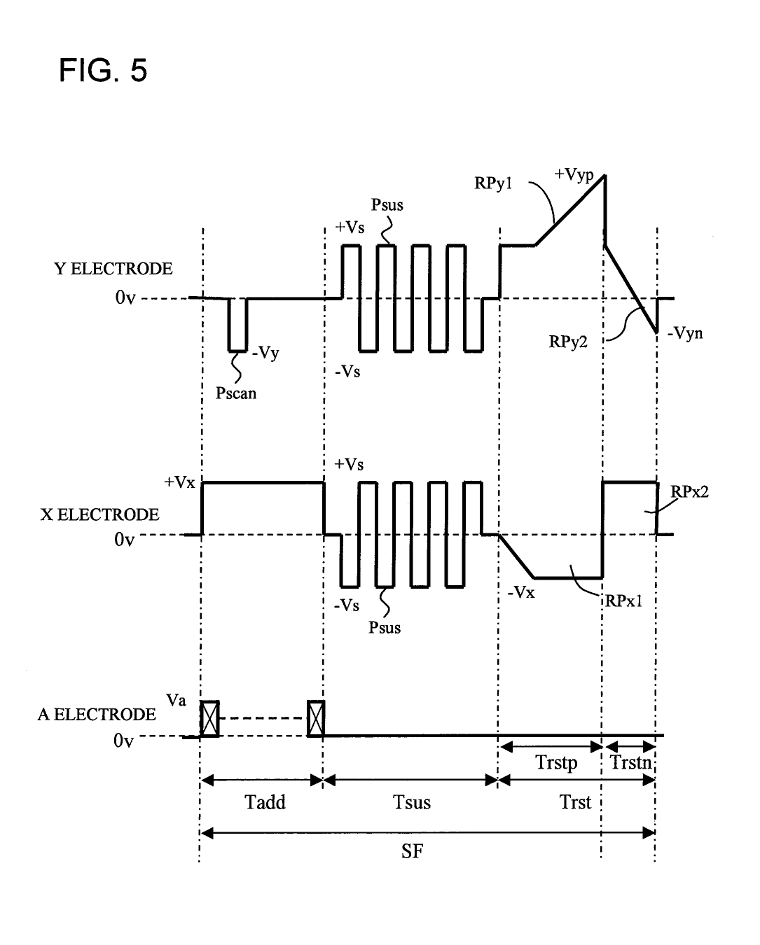

FIG. 5 is a diagram depicting a drive voltage waveform of a subfield according to the present embodiment. The voltage drive waveform in FIG. 5 shows an example of a drive voltage waveform of a typical subfield, out of a plurality of types of subfields. FIG. 5 shows the respective drive voltage waveforms of the Y electrode, X electrode and address electrode. As mentioned above, the drive control for the X and Y electrodes and address electrode of one subfield SF is a drive control for the address period Tadd first, then the sustain period Tsus and finally the reset period Trst. Therefore when the address period Tadd in the drive voltage waveform of FIG. 5 starts, each cell is in a state where the drive control for the reset period of the previous subfield has been completed.

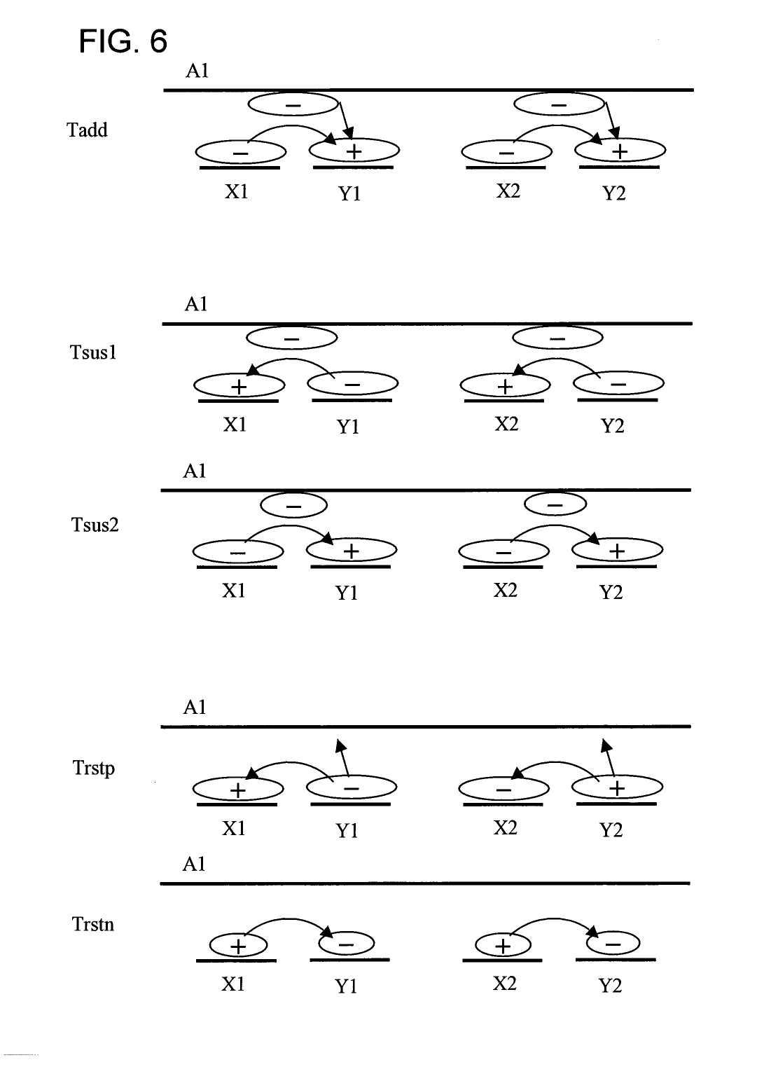

FIG. 6 are diagrams depicting the wall charge state on the three electrodes corresponding to the drive voltage waveform in FIG. 5. FIG. 6 shows the respective wall charge states at the end of the address period Tadd, at the end of the two sustain discharges Tsus1 and Tsus2, and at the end of the two reset discharges Trstp and Trstn. Each state shows two pairs of display electrodes X1/Y1 and X2/Y2, corresponding to the address electrode A1, and a polarity of the wall charges on these electrodes is shown by +or −, and the charge amount thereof is indicated by a size of the ellipse respectively.

Now the drive operation in a typical subfield will be described with reference to FIG. 5 and FIG. 6. When the first address period Tadd is started, the reset driving in the previous subfield has been completed. For example, this is a state where the second reset discharge Trstn in FIG. 6 has been completed, and an appropriate amount of charges have been formed on the address electrode A1, and adjusted amount of positive charges exist on the Y electrode and negative charges on the X electrode.

Then in the address period Tadd, the X side common drive circuit drives the X electrode to the voltage +Vx, and the Y scanning drive circuit sequentially applies a negative scan pulse Pscan to the Y electrodes, and synchronizing with this, the address electrode drive circuit applies the address voltage Va to the address electrode of the write target cell corresponding to the display data. As FIG. 6 shows, the voltages generated by the negative charges on the Y electrode and positive charges on the address electrode are added to the negative voltage −Vy of the Y electrode and the positive address voltage Va of the address electrode, and are applied between the address electrode and the Y electrode (between AY), and an address discharge is generated between AY. Induced by this address discharge between A and Y, a discharge is generated between the X electrode and Y electrode (between XY). As a result, when the address period Tadd completes, positive charge are formed on the Y electrode, and negative charges are formed on the X electrode and negative charges are formed on the address electrode respectively in the written cell, as shown in Tadd in FIG. 6. The charge amounts on the X and Y electrodes, in particular, are controlled to be a level with which a discharge is generated if a sustain pulse is applied thereafter.

Then in the sustain period Tsus, the address electrode drive circuit maintains the address electrode at 0V (ground), and the Y side and X side common drive circuits apply the sustain pulse Psus, which changes between voltage +Vs and −Vs, to the Y electrode and X electrode, to be opposite polarities. As a result, 2Vs of the sustain pulse voltage is alternately applied between the X and Y electrodes. As Tsus1 in FIG. 6 shows, when an odd numbered sustain pulse is applied, a sustain discharge is generated from the Y electrode to the X electrode, as the arrow marks indicate. As a result, the polarities of the charges on the X and Y electrodes reverse. Also as Tsus2 shows, when an even numbered sustain pulse is applied, a sustain discharge is generated from the X electrode to the Y electrode, as the arrow marks indicate. As a result, the polarities of the charges on the X and Y electrodes return to the original state.

In the above sustain period, the address electrode is maintained at ground level, which is a mid-value of voltages applied to the X and Y electrodes, so even if negative charges exist on the address electrode at the end of the address period, a discharge is not generated between A and Y or between A and X. However, a sustain discharge is repeated so negative charges on the address electrode are emitted to the discharge space, and gradually decrease.

Finally in the reset period Trst, a positive polarity slope pulse RPy1 is applied to the Y electrode, and a negative polarity slope pulse RPx1 is applied to the X electrode by the Y side and X side common drive circuits, and a first reset discharge Trstp (see FIG. 6) is generated. Then the negative polarity slope pulse RPy2 is applied to the Y electrode, and the positive polarity rectangular pulse RPx2 is applied to the X electrode respectively, and the second reset discharge Trstn (see FIG. 6) is generated.

In the first reset discharge Trstp, a positive voltage is applied to the Y electrode, and voltage which gradually decreases from ground level to voltage −Vx is applied to the X electrode, and the X electrode is maintained at a negative voltage −Vx, and a voltage which gradually increases to ultimate voltage +Vyp is applied to the Y electrode. In other words, the positive slope pulse RPy1 is applied to the Y electrode, and the negative slope pulse RPx1 is applied to the X electrode respectively. Thereby the applied voltage between X and Y gradually increases from zero, and a weak discharge is repeatedly generated between the X and Y electrodes of ON cells, from the Y electrode to the X electrode direction. If the applied voltage between X and Y increases even more, a weak discharge is also repeatedly generated between X and Y of OFF cells. If the ultimate voltage +Vyp is not high, however, a weak discharge is generated only in ON cells, and a weak discharge is not generated in OFF cells.

In the first reset discharge Trstp, voltage, which gradually increases, is also applied between the Y electrode and address electrode, and a weak discharge is generated in a direction from the Y electrode to the address electrode. Sufficient amounts of negative charges and positive charges are generated on the Y electrode and X electrode respectively by the first reset discharge Trstp, and negative charges on the address electrode are removed. A small amount of positive charges or negative charges may be generated on the address electrode, but it is preferable that charges on the address electrode are removed.

Then in the second reset discharge Trstn, the positive polarity rectangular pulse RPx2 is applied to the X electrode, and negative polarity slope pulse RPy2 is applied to the Y electrode by the Y side and X side common drive circuits. Thereby the reverse polarity voltage, which gradually increases, is applied between the X and Y electrodes, and a weak discharge is repeatedly generated in a direction from the X electrode to the Y electrode by the above voltages to which positive and negative charges on the X and Y electrodes, generated by the first reset discharge, are added. As a result, the amount of positive and negative charges on the X and Y electrodes gradually decrease and the charge amount is adjusted to be optimum. The charge amount to be adjusted is an amount corresponding to the voltage of the pulse RPx1 of the X electrode and the ultimate voltage −Vyn of the negative polarity slope pulse RPy2 to be applied to the Y electrode.

If the ultimate voltage +Vyp of the slope pulse RPy1 of the Y electrode in the first reset discharge is high, a sufficient amount of positive and negative charges are generated on the X and Y electrodes respectively in both light ON cells and light OFF cells, and are adjusted to optimum charge amounts in the second reset charge. On the other hand, if the ultimate voltage +Vyp of the slope pulse RPy1 of the Y electrode is not high in the first reset discharge, a sufficient amount of positive and negative charges are formed on the X and Y electrodes only in ON cells, and are adjusted to optimum charge amounts in the second reset discharge. The OFF cells, where neither an address discharge nor sustain discharge are generated, is maintained in the initial state when the firstly conducted all cells reset discharge ended, and the charge amount remains optimum. If the first reset discharge Trstp was not performed, the sustain period has been ended in the ON cells in a state after an odd numbered sustain discharge ended (Tsus1 in FIG. 6), and since a sufficient amount of positive and negative charges are generated on both X and Y electrodes, these charge amounts are adjusted to an optimum amount in the second reset discharge Trstn.

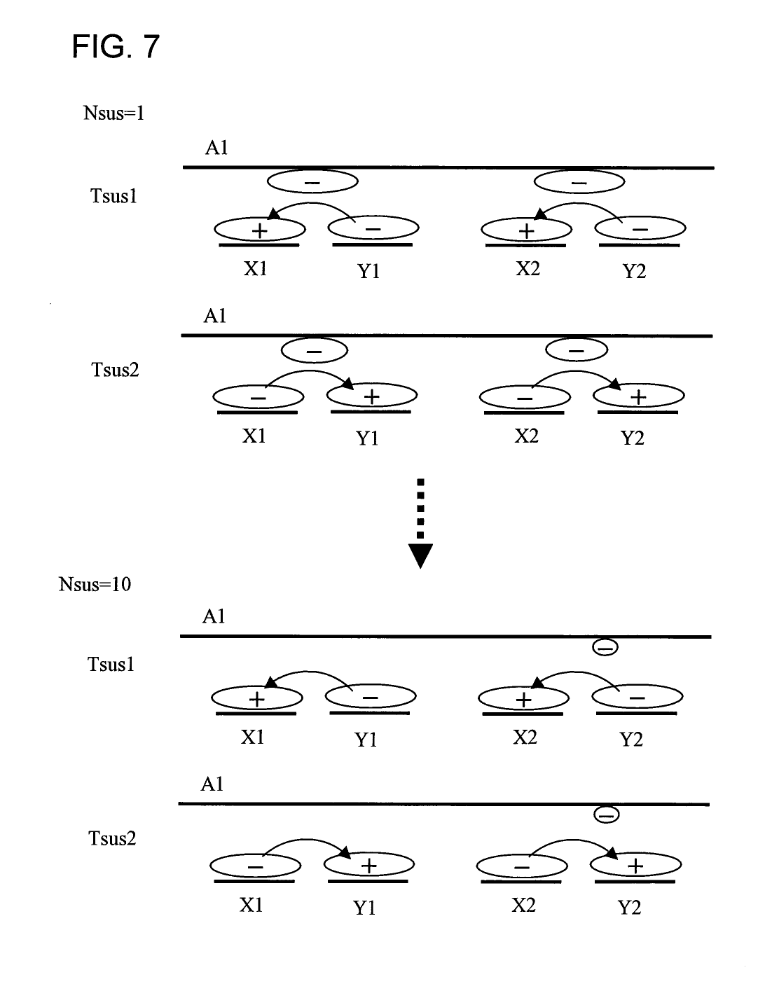

FIG. 7 are diagrams depicting the wall charge states on three electrodes in the sustain period. FIG. 7 shows the wall charge states on the three electrodes at the end of the sustain period according to the sustain pulse count Nsus. A case of sustain pulse count Nsus=1 and Nsus=10 is shown as an example.

As shown in FIG. 6, the wall charge state of ON cells at the end of the address period Tadd is that positive charges are formed on the Y electrodes, negative charges are formed on the X electrodes, and negative charges are formed on the address electrode respectively. In sustain driving, the address electrode is maintained at intermediate potential, that is, at ground level, and the sustain pulse is alternately applied between the X and Y electrodes. Thereby the polarities of the wall charges on the X and Y electrodes are alternately reversed. While the sustain discharge count is low, however, negative charges exist on the address electrode, and status is unstable.

In the case of the sustain pulse count Nsus=1 shown in FIG. 7, a strong discharge is generated in the first sustain discharge Tsus1 in a direction from the Y electrode to the X electrode, and in the next sustain discharge Tsus2, a strong discharge is generated in a direction from the X electrode to the Y electrode. At this time, the address electrode is maintained at ground level, and negative wall charges remain, so a discharge is generated between the address electrode and the Y or X electrode as well, that is, the status is unstable. In other words, if the sustain discharge count is low after the address period, negative wall charges exist on the address electrode. Therefore in a subfield of which display brightness is very low, the sustain discharge count is very low, so the state at the end of the sustain period is that negative and positive charges are generated on the X and Y electrodes respectively, and negative charges are generated on the address electrode.

If the sustain pulse count Nsus becomes about 10, however, wall charges on the address electrode are attracted to the discharge space, and the amount thereof decreases because of a repeat of the strong discharge between the X and Y electrode, and as shown in FIG. 7, negative wall charges slightly remain in a part of the cells (cells between X2 and Y2). If the sustain pulse count exceeds this, the state of Nsus=10 in FIG. 7 is stably reproduced. In other words, in the subfield of which sustain discharge count is sufficiently high, negative and positive charges are generated on the X and Y electrodes respectively at the end of the sustain period, and none or a few charges are generated on the address electrode.

As mentioned above, in the subfield of which sustain discharge count is relatively low, the wall charge state at the end of the sustain period differs depending on the sustain discharge amount. The negative wall charge amount in particular on the address electrode is different. Because of this difference of the wall charge state, if reset drive is performed using the same reset drive voltage waveform, an ideal reset discharge may be generated in some subfields, but a reset failure may be generated in other subfields.

For example, in the case of a subfield where Nsus≧10, which generates a relatively high frequency among a plurality of types of subfields, if a reset drive voltage waveform is set corresponding to a subfield of Nsus≧10, a reset failure occurs in a subfield of which the sustain discharge count is lower than Nsus=10. If a reset drive voltage waveform is set corresponding to a subfield of which sustain discharge count is low, on the other hand, a reset failure occurs in a subfield of which sustain discharge count is high.

In particular, in a case of dynamically controlling a sustain pulse count in each subfield according to the display load ratio and temperature state of the panel, a reset failure may be generated if a predetermined reset drive voltage waveform is used.

Here an ideal reset discharge means that an appropriate amount of positive and negative charges are stored on the X and Y electrodes by primarily repeating a micro-discharge between the X and Y electrodes in the first reset discharge, and at the same time, some micro-discharges are generated between the address electrode and the Y electrode to remove the negative wall charges on the address electrode, and in the second reset discharge, the charge amounts on the X and Y electrodes are adjusted. In other words, in the first reset discharge, it is necessary that a weak discharge is primarily generated between the X and Y electrodes, but it is difficult not to generate a discharge between the A and Y electrodes at all. Therefore according to the wall charge states on the three electrodes at the end of the sustain period, the balance of reset voltages to be applied to the two electrodes must be optimized, whereby the above mentioned ideal reset discharge is generated with is certainty.

### [Improvement of Reset Drive Voltage Waveform]

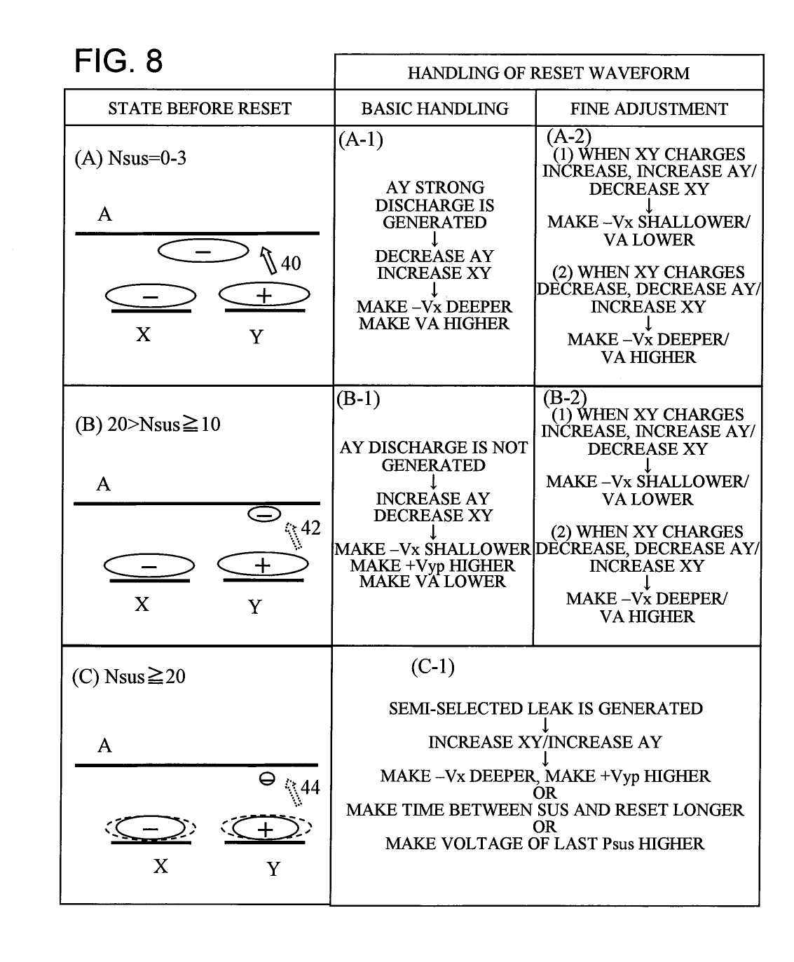

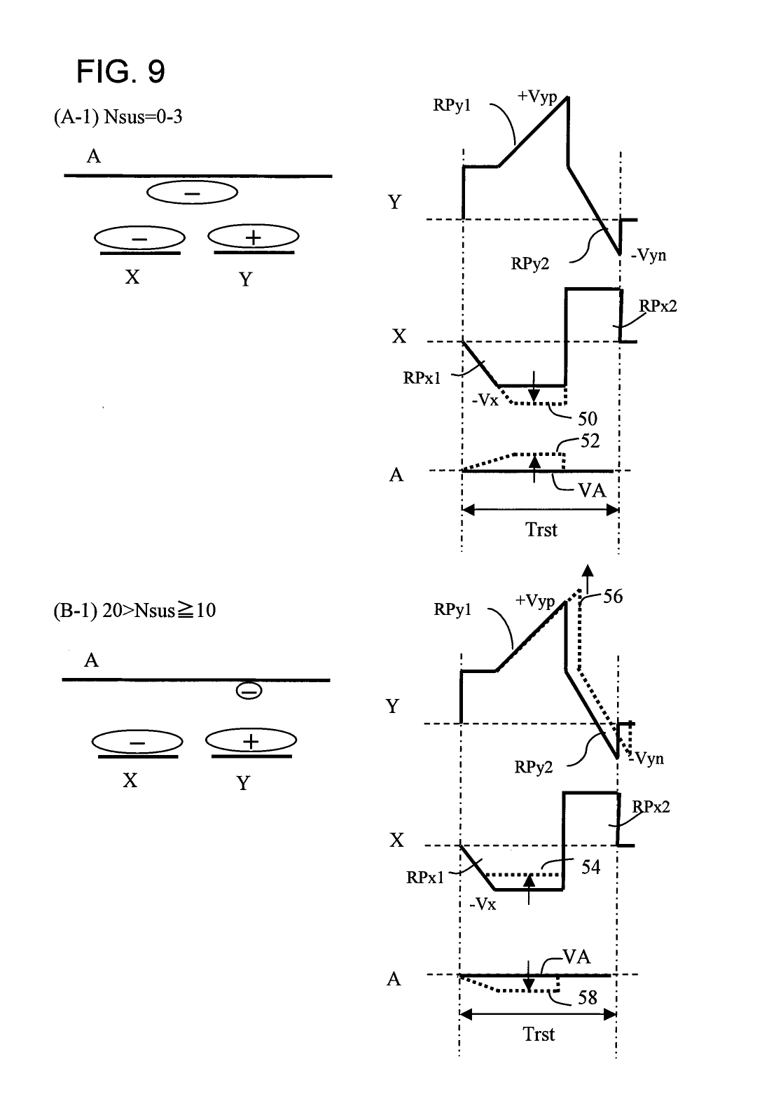

FIG. 8 shows an example of improving the reset drive voltage waveform according to the present embodiment. FIG. 9 to FIG. 15 show the reset drive voltage waveforms according to each case. First an outline of the improvement of the reset drive voltage waveform according to the present embodiment will be described with reference to FIG. 8, then an individual waveform will be described with reference to FIG. 9 to FIG. 15.

The table in FIG. 8 shows three cases of wall charge states at the end of the sustain period, in other words, just before reset, in the left column, (A) the sustain discharge count is very low, which is a first count (e.g. Nsus=0 to 3), (B) the sustain discharge count is relatively low, which is a second count (e.g. 20>Nsus≧10), and (C) the sustain discharge count is relatively high, which is a third count (e.g. Nsus≧20). In the right column, improvement of the reset drive voltage waveform is shown in two stages: basic countermeasures (A-1), (B-1) and (C-1), and fine adjustments (A-2) and (B-2). The first, second and third counts are in a relationship of ascending order.

### [Basic Countermeasures for Reset Drive Voltage Waveform]

When (A) the sustain discharge count is very low, such as Nsus=0 to 3, negative and positive wall charges are generated on the X and Y electrodes respectively, and negative wall charges are also generated on the address electrode A, as described in FIG. 7. Generally, a weak surface discharge (weak discharge) easily occurs between X and Y electrodes formed on the front substrate responding to an applied slope pulse, but a strong counter discharge (strong discharge) easily occurs between the X electrode and address electrode, or Y electrode and address electrode formed on the front substrate and back substrate. Therefore if a positive polarity slope pulse RPy1 is applied to the Y electrode in a wall charge state in which negative charges exist on the address electrode, a discharge occurs between the A and Y electrodes before it occurs between the X and Y electrodes, because of the negative charges on the address electrode and the positive charges on the Y electrode, and that discharge can be a strong discharge 40 as shown in FIG. 8.

Once a strong discharge 40 occurs between the A and Y electrodes, positive charges are generated on the address electrode, and negative charges are generated on the Y electrode, that is, negative charges are generated on both the X and Y electrodes, so a weak discharge no longer occurs between the X and Y electrodes, and a reset failure occurs. In this state, an address discharge cannot be generated between the Y and X electrodes in the subsequent address period, and also a discharge is not generated even in the sustain period.

In some cases, once a strong discharge occurs between the A and Y electrodes, a strong discharge may also be generated between X and Y. In this case, positive and negative charges are generated on the X and Y electrodes respectively, which is equivalent to the state after writing is performed by an address discharge, although polarities of the charges are reversed. Therefore a sustain discharge is generated even in cells which should not turn ON in the subsequent sustain period. This means an excess lighting.

Hence when (A) the sustain discharge count is very low, such as Nsus=0 to 3, a basic countermeasure is not to generate a strong discharge between the A and Y electrodes, but to generate a weak discharge primarily between the X and Y electrodes, as shown in (A-1). Specifically, the voltage between A and Y electrodes is decreased, and the voltage between the X and Y electrodes is increased in the first reset discharge. In order to increase the voltage between the X and Y electrodes, it is preferable to set the voltage −Vx, to be applied to the X electrode, to be deeper (higher negative voltage). In order to decrease the voltage between the A and Y electrodes, it is preferable to increase the voltage VA of the address electrode.

FIG. 9 shows reset drive voltage waveforms of the basic countermeasures (A-1) and (B-1) according to the present embodiment. In basic countermeasure (A-1) Nsus=0 to 3, which is a case when the sustain discharge count is very low, the voltage −Vx of the reset pulse RPx1 at the X electrode side in the first reset discharge is set to be deeper (higher negative voltage), as indicated by the arrow 50. Here the solid line indicates the reset pulse voltage in a normal subfield, of which sustain discharge count Nsus is 20 or more times, for example, and the broken line indicates the reset pulse voltage −Vx when Nsus is 0 to 3. By setting the voltage −Vx of the X electrode to be a higher negative voltage, the voltage between the Y electrode and X electrode can be strengthened. Also the voltage on the address electrode in the first reset discharge is set to be higher, as indicated by arrow 52. In other words, the voltage of the address electrode is increased from ground to a positive voltage. Thereby the voltage between the address electrode and Y electrode can be decreased.

By performing one or both of the measures indicated by arrows 50 and 52, a weak discharge between the X and Y electrodes can be generated with certainty in the first reset discharge, and the generation of a strong discharge between the A and Y electrodes can be suppressed.

When the sustain discharge count is relatively low, such as the case of basic countermeasure (B-1) 20>Nsus≧10, most of the negative wall charges on the address electrode are lost, and negative and positive wall charges are generated on the X and Y electrodes respectively at the end of the sustain period. In this status, the negative wall charge amount on the address electrode is lower compared with the case of (A-1), that is when the sustain discharge count is very low, so the probability of a strong discharge to be generated between the A and Y electrodes is low. Therefore a weak discharge frequently occurs between the X and Y electrodes in the first reset discharge. However, it is difficult for a reset discharge between the A and Y electrodes to occur, since the negative charge amount on the address electrode is low. Since negative wall charges may remain on the address electrode, it is ideal to remove the negative wall charges by also generating a discharge between the A and Y electrodes in the first reset discharge, and countermeasures for this are desirable.

Therefore in the basic countermeasure (B-1), the voltage between the A and Y electrodes is increased, and/or the voltage between the X and Y electrodes is decreased. Specifically, as shown in FIG. 9, the voltage −Vx of the reset pulse RPx1 at the X electrode side in the first reset discharge is set to be shallower (lower negative voltage), as indicated by arrow 54. Or the ultimate voltage +Vyp of the reset pulse RPy1 at the Y electrode side in the first reset discharge is set to be higher, as indicated by arrow 56. Then the voltage VA of the address electrode in the first reset discharge is set to be lower, as indicated by arrow 58. Here the solid line indicates a reset pulse voltage in the subfield of which sustain discharge count is very low, such as Nsus=0 to 3, and the broken line indicates the reset pulse voltage −Vx when 20>Nsus≧10.

By setting the voltage −Vx of the X electrode to be shallower (lower negative voltage), or setting the ultimate is voltage +Vyp of the Y electrode to be higher, or setting the voltage VA of the address electrode to be lower, or combining these countermeasures, the voltage between the A and Y electrodes can be relatively increased compared with the voltage between the X and Y electrodes, and the voltage between the Y electrode and X electrode can be relatively decreased. For example, by setting the voltage −Vx of the X electrode to be shallower (lower negative voltage) and setting the ultimate voltage +Vyp of the y electrode higher, the voltage between the A and Y electrodes can be increased without changing the voltage between the X and Y electrodes.

The same functional effect can also be obtained merely by setting the voltage VA of the address electrode to be lower. On the other hand, the voltage between the X and Y electrodes can be decreased by setting the voltage −Vx of the X electrode to be shallower (lower negative voltage). If only the ultimate voltage +Vyp of the Y electrode is set high, both voltages between the A and Y electrodes and between the X and Y electrodes are increased, which is not preferable.

### [Fine Adjustment of Reset Drive Voltage Waveform]

Now a fine adjustment method for when (A) the sustain discharge count is very low, which is a first count (e.g. Nsus=0 to 3), and when (B) the sustain discharge count is relatively low, which is a second count (e.g. 20>Nsus≧10), will be described. It was described that the voltage between the X and Y electrodes and the voltage between the A and Y electrodes are increased or decreased, depending on case (A), when the sustain count is very low, and case (B), when the sustain count is relatively low, but higher than (A). However, besides using a same sustain pulse which is repeatedly applied during a sustain period (hereafter called “repeat sustain pulse), a high voltage sustain pulse or sustain pulse with a wide pulse width may be applied at the beginning, or a high voltage or low voltage sustain pulse may be applied at the end. Or, the rise of only one sustain pulse may be slower. In this way, in some cases, a sustain pulse which is different from the repeat sustain pulse (hereafter called specified sustain pulse) may be adjusted based on a predetermined reason. In other words, a specified sustain pulse may be different, even if the subfield is the same and the sustain discharge count is the same.

In this case, it is preferable to not only perform basic countermeasures (A-1) and (B-1) according to the sustain discharge count, as mentioned above, but also to perform fine adjustment on the reset drive voltage waveform after performing the respective basic countermeasure, according to the specified sustain pulse.

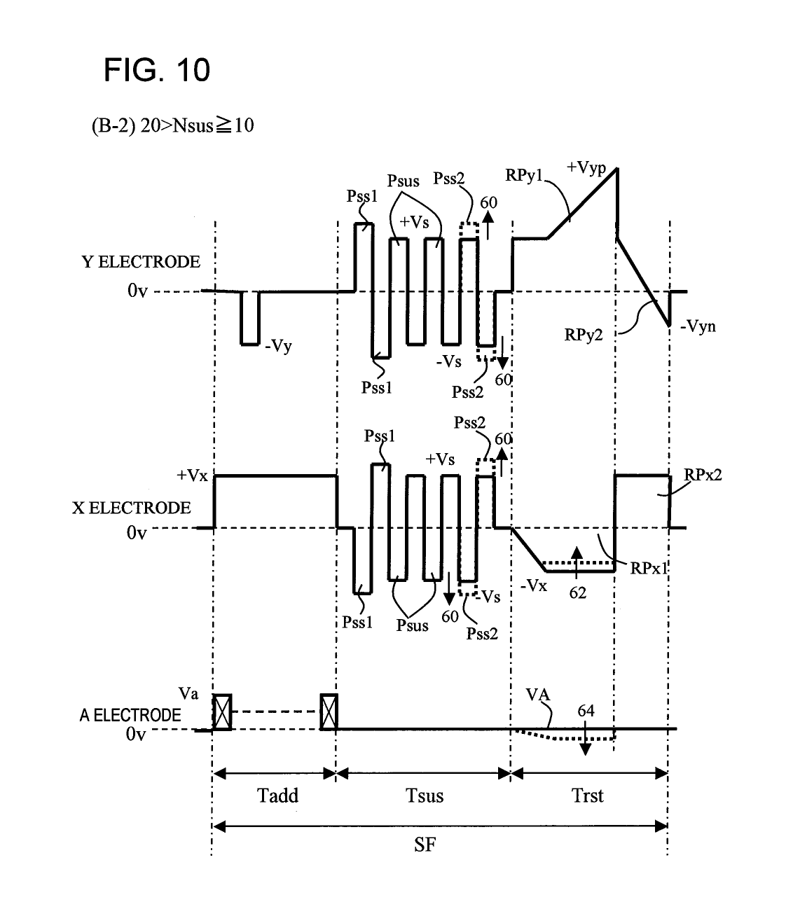

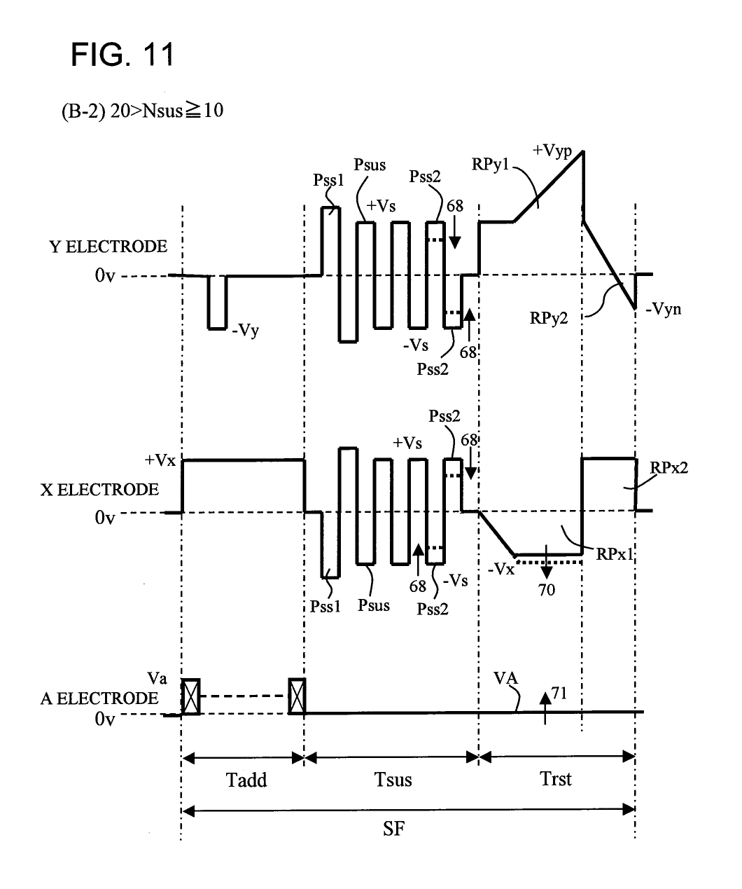

FIG. 10 and FIG. 11 show the fine adjustment (B-2) of the reset drive voltage waveform in the case when (B) the sustain discharge count is relatively low, which is a second count (e.g. 20>Nsus≧10). This fine adjustment will be described with reference to the fine adjustment (B-2) in FIG. 8 as well.

According to the drive voltage waveform shown in FIG. 10, in the sustain period Tsus, the repeat sustain pulse Psus and the specified sustain pulses Pss1 and Pss2 at the start and end of the period are applied to the X and Y electrodes sequentially with reverse polarities. The specified sustain pulse Pss1 is a voltage which is higher than the voltage of the repeat sustain pulse Psus, for example. As another example, the pulse width may be wider. The specified sustain pulse Pss2 is a voltage which is higher than the voltage of the repeat sustain pulse Psus, for example (see arrow 60). By applying the voltage of the specified sustain pulse Pss2, the wall charge amounts on the X and Y electrodes at the end of the sustain period are slightly more than the case of ending the sustain period with a normal repeat sustain pulse Psus.

Therefore for fine adjustment, it is preferable to slightly increase the voltage between the A and Y electrodes, or to slightly decrease the voltage between the X and Y electrodes, or to perform both of these adjustments. In other words, in the first reset discharge, the voltage of the first reset pulse RPx1 of the X electrode is set to be slightly shallower (lower negative voltage), as indicated by arrow 62, or the voltage VA of the address electrode is set to be slightly lower, or both of these adjustments are performed. Thereby the voltage between the A and Y electrodes can be relatively higher than that between the X and Y electrodes, and an ideal reset discharge, that is, generating a reset discharge between the A and Y electrodes while generating a weak discharge between the X and Y electrodes, can be implemented.

According to the drive voltage waveform shown in FIG. 11, in the sustain period Tsus, a repeat sustain pulse Psus and specified sustain pulses Pss1 and Pss2 are applied, just like FIG. 10. And the voltage of the specified sustain pulse Pss2 at the end of the period is set to be lower than the repeat sustain pulse Pss (see arrow 68). Because the low voltage of this specified sustain pulse is low, the scale of the last sustain discharge becomes small, and the wall charge amounts on the X and Y electrodes at the end of the sustain period are slightly less than the case of ending the sustain period with a normal repeat sustain pulse Psus.

Therefore for fine adjustment, it is preferable to slightly decrease the voltage between the A and Y electrodes, or to slightly increase the voltage between the X and Y electrodes, or to perform both of these adjustments. In other words, in the first reset discharge, the voltage of the first reset pulse RPx1 of the X electrode is set to be slightly deeper (higher negative voltage), as indicated by arrow 70, or the voltage VA of the address electrode is set to be slightly higher (see arrow 71), or both of these adjustments are performed. Thereby the voltage between the X and Y electrodes can be relatively higher than between the A and Y electrodes, and an ideal reset discharge, that is, while primarily generating a weak discharge between the X and Y electrodes, generating also a reset discharge between the A and Y electrodes can be implemented.

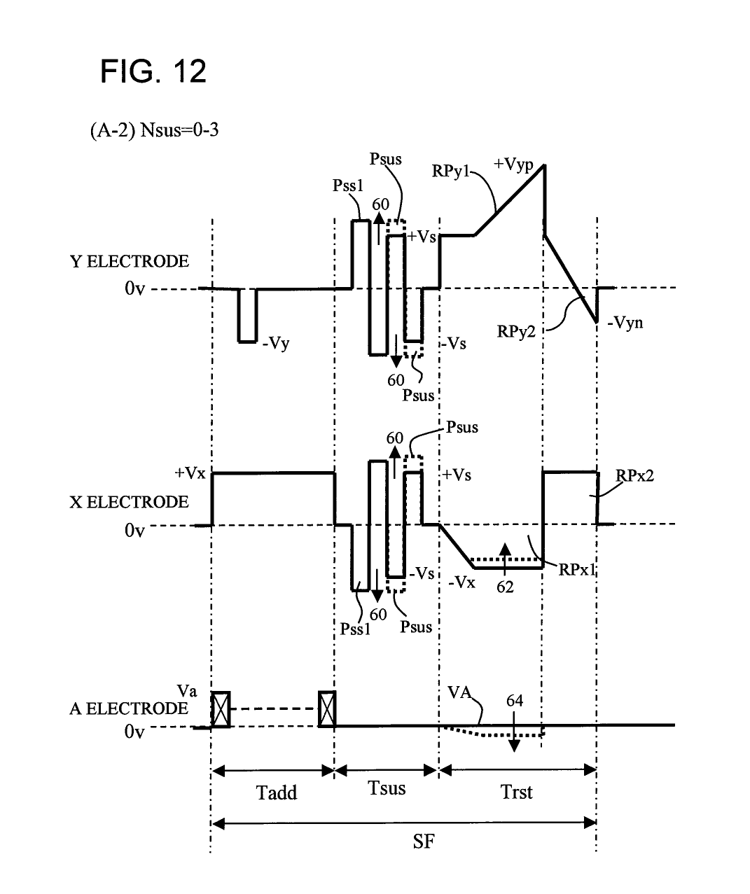

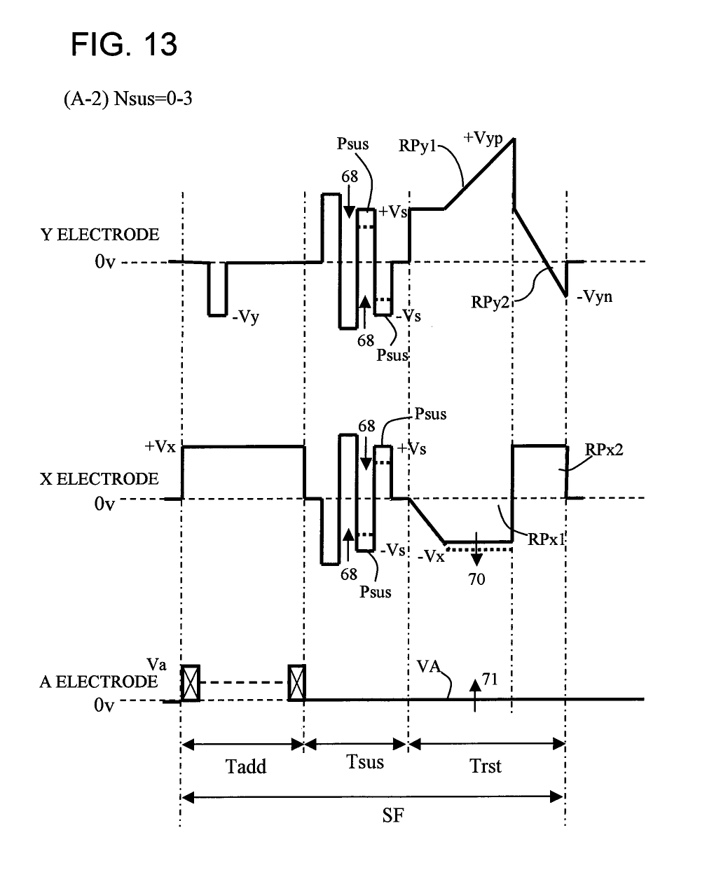

FIG. 12 and FIG. 13 show the fine adjustment (A-2) of the reset drive voltage waveform in the case when (A) the sustain discharge count is extremely low, which is a first count (e.g. Nsus=0 to 3). This fine adjustment will be described with reference to the fine adjustment (A-2) in FIG. 8 as well.

According to the drive voltage waveform shown in FIG. 12, in the sustain period Tsus, one repeat sustain pulse Psus and a specified sustain pulse Pss1 at the start of the period are applied to the X and Y electrodes with reverse polarities. And in order to make a subtle brightness adjustment of the subfield, that is, in order to increase the brightness less than increase the sustain discharge count once, for example, the voltage of the repeat sustain pulse Psus is increased more than the normal voltage (see arrow 60). In this case, even if the sustain discharge count Nsus is twice, the wall charge amounts on the X and Y electrodes at the end of the sustain period increases slightly compared with the normal sustain pulse, for the amount of increase of the voltage of the sustain pulse Psus.

Therefore for fine adjustment, it is preferable to slightly increase the voltage between the A and Y electrodes, or to slightly decrease the voltage between the X and Y electrodes, or to perform both of these adjustments. In other words, in the first reset discharge, the voltage of the first reset pulse RPx1 of the X electrode is set to be slightly shallower (lower negative voltage), as indicated by arrow 62, or the voltage VA of the address electrode is set to be slightly lower, as indicated by arrow 64, or both of these adjustments are performed. Thereby the voltage between the A and Y electrodes can be relatively higher than between the X and Y electrodes, and an ideal reset discharge, that is, generating a reset discharge between the A and Y electrodes while generating a weak discharge between the X and Y electrodes, can be implemented. Clearly this fine adjustment is performed in addition to designing a reset drive voltage waveform based on the basic countermeasure (A-1).

According to the drive waveform shown in FIG. 13, the voltage of the repeat sustain pulse Psus is set to be lower than usual, which is the opposite of FIG. 12 (see arrow 68). Thereby subtle brightness adjustment becomes possible. In this case, even if the sustain discharge count Nsus is twice, the wall charge amounts on the X and Y electrodes at the end of the sustain period slightly decreases for the amount of the drop in voltage of the sustain pulse Psus.

Although this is not illustrated, if the inclination of the rise of the sustain pulse Psus is milder, even if the voltage thereof is the same, a dispersed discharge can be generated, and the sustain discharge scale can be decreased, thereby brightness can be decreased. In this case as well, the wall charge amounts on the X and Y electrodes at the end of the sustain period decrease slightly, compared with the normal sustain pulse.

Therefore for fine adjustment, it is preferable to slightly decrease the voltage between the A and Y electrodes, or to slightly increase the voltage between the X and Y electrodes, or to perform both of these adjustments. In other words, in the first reset discharge, the voltage of the first reset pulse RPx1 of the X electrode is set to be slightly deeper (higher negative voltage), as indicated by arrow 70, or the voltage VA of the address electrode is set to be slightly higher (see arrow 71), or both of these adjustments are performed. Thereby the voltage between the X and Y electrodes can be relatively higher than between the A and Y electrodes, and an ideal reset discharge, that is, generating a reset discharge between the A and Y electrodes while generating a weak discharge between the X and Y electrodes, can be implemented. This fine adjustment as well, is performed in addition to the waveform design based on the basic countermeasure (A-1).

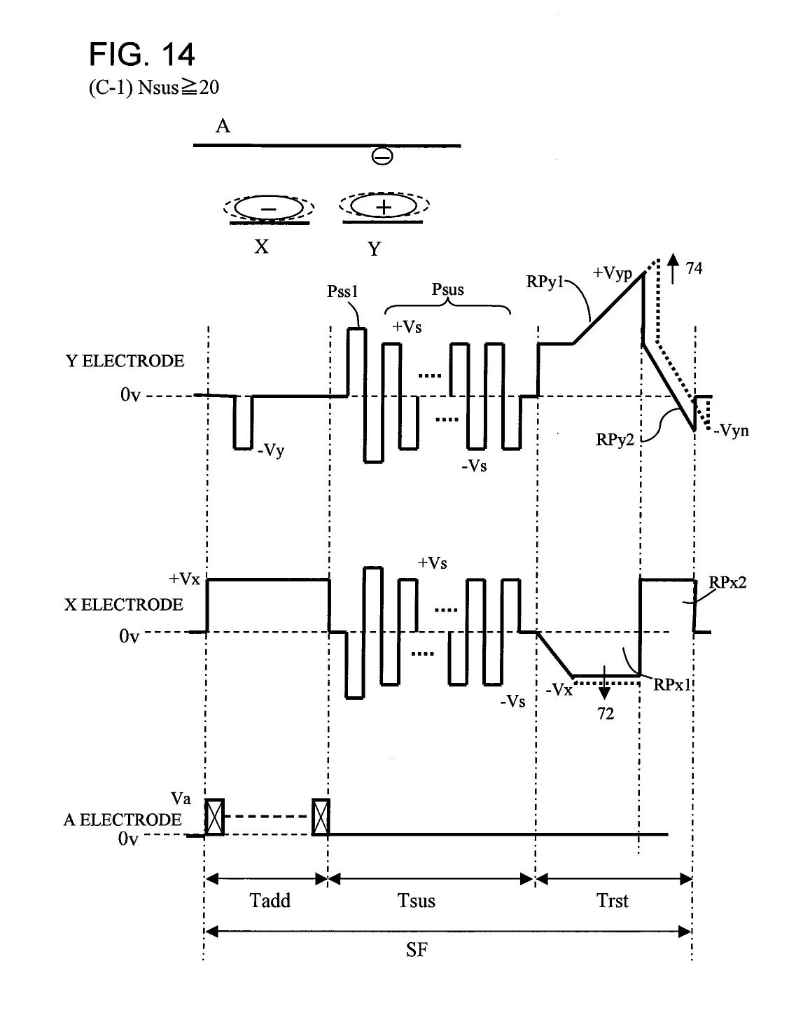

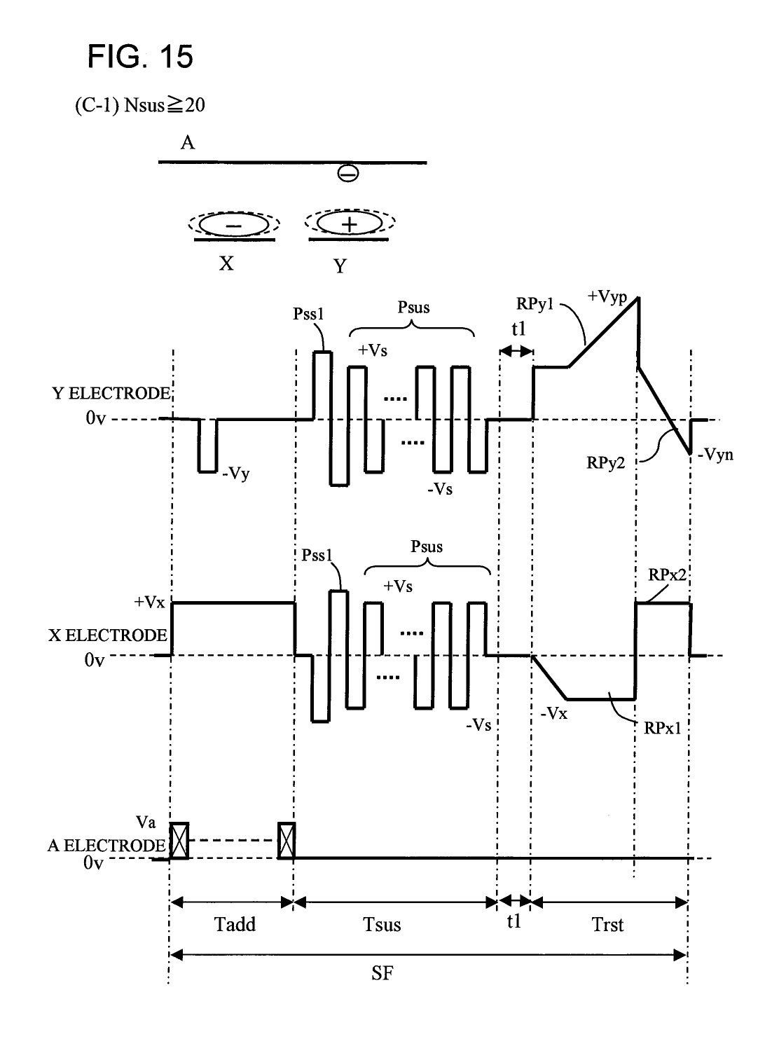

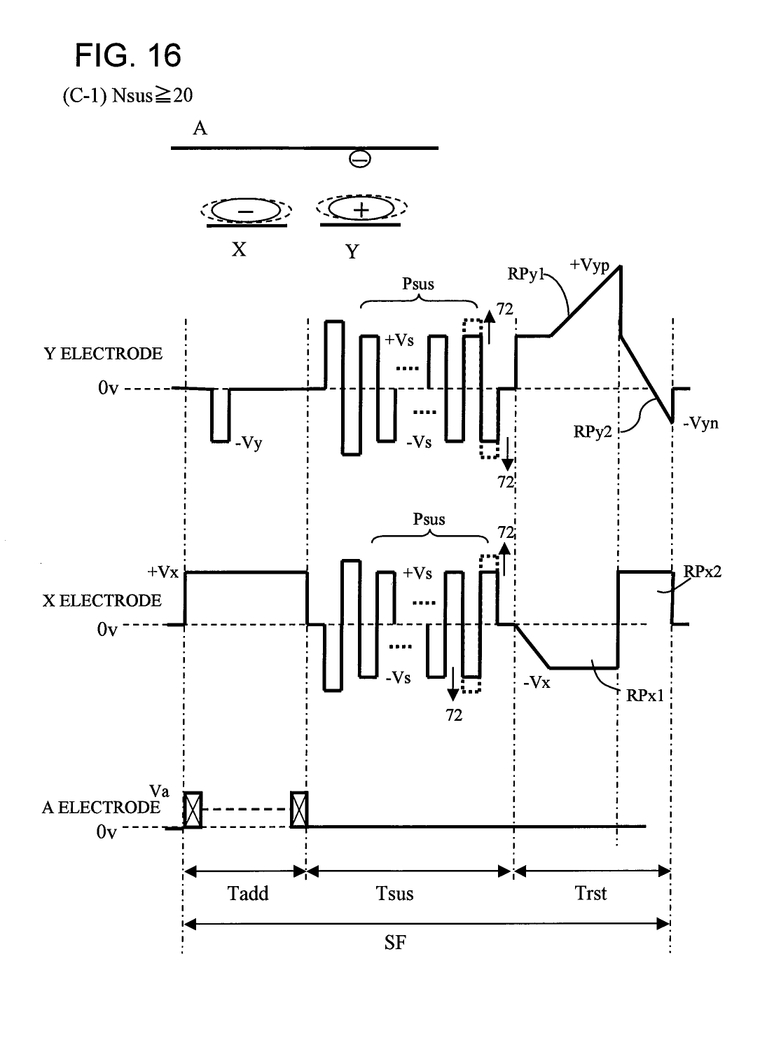

FIG. 14, FIG. 15 and FIG. 16 show the basic countermeasure (C-1) of the reset drive voltage waveform in the case when (C) the sustain discharge count is relatively high, which is a third count (e.g. Nsus≧20). This countermeasure will be described with reference to the basic countermeasure (C-1) in FIG. 8 as well.

In the case of a sub-frame of which sustain discharge count is relatively high, such as the case of a repeat sustain pulse Psus count exceeding 20 times, the temperature of the panel temporarily increases, because of the increase of the discharge count, and a discharge easily occurs. On the other hand, in the second reset discharge in the reset period Trst, the negative polarity pulse RPy2 is applied to the Y electrode, and the pulse RPx2, having the same voltage as the address time, is applied to the X electrode, and a state where an address pulse Va is not applied to the address electrode occurs. This state is the same as the semi-selected cell (scan pulse is applied to the Y electrode of the scan electrode, but the address pulse Va is not applied to the address electrode) in the address period Tadd. In the semi-selected cell, it is known that the wall charges on the X and Y electrodes leak into the discharge space, and charges decrease.

By the rise of the panel temperature because of a high sustain discharge count, the charge leak increases in the semi-selected cell state in the second reset discharge, and the wall charge amounts on the X and Y electrodes decrease. In other words, as shown in the upper area in FIG. 14 to FIG. 16, the wall charges indicated by the broken line decrease, as indicated by the solid line. This decrease of the wall charge amounts on the X and Y electrodes cause a phenomena where cells, which should turn ON, do not turn ON in the address period (lighting error). Therefore in the case of a sub-frame of which sustain discharge count is relatively high, it is preferable not to decrease the wall charge amounts on the X and Y electrodes after reset.

In FIG. 14, the count of the repeat sustain pulse Psus in the drive voltage waveform is relatively high. In this case, a countermeasure is to increase the voltage between the X and Y electrodes in the first reset discharge, and specifically, the voltage −Vx of the first reset pulse RPx1, to be applied to the X electrode, is set to be deeper (higher negative voltage) (see arrow 72). Thereby the amounts of the wall charges on the X and Y electrodes generated in the first reset discharge can be increased, and a decrease in the wall charge amount due to a charge leak in the semi-selected sate in the second reset discharge can be compensated.

When the sustain discharge count is relatively high, the amount of negative wall charges on the address electrode further decreases, as shown in (C) of FIG. 8. Hence it is expected that the reset discharge between the A and Y electrodes tend not to occur in the first reset discharge. A preferable countermeasure in this case is to increase the voltage between the A and Y electrodes in the first reset discharge. Specifically, as shown in FIG. 14, the ultimate voltage +Vyp of the first reset pulse RPy1, to be applied to the Y electrode, is further increased (see arrow 74).

In FIG. 15 as well, the count of the repeat sustain pulse Psus of the drive voltage waveform is relatively high. In this case, a countermeasure is to create a predetermined length of time t1 between the end of the sustain period Tsus and the start of the reset period Trst. Because of the presence of interval time t1, the leak of charges in the second reset discharge is suppressed. The reason is not certain, but is probably due to the panel temperature dropping due to interval time t1.

In FIG. 16 as well, the count of the repeat sustain pulse Psus in the drive voltage waveform is relatively high. In this case, a countermeasure is to set the voltage of the last pulse of the repeat sustain pulse Psus to be higher than the voltages of other pulses (see arrow 72). Thereby the scale of the last sustain discharge increases, and the wall charge amounts on the X and Y electrodes can be increased accordingly. Hence the discharge scale in the subsequent first reset discharge increases, whereby the wall charge amounts on the X and Y electrodes can be increased, and a decrease in the charge amounts, due to a charge leak in the second reset discharge, can be compensated.

As described above, according to the present embodiment, the reset drive voltage waveform is individually set according to the sustain discharge count in the sustain period in the subfield. For example, in the case when the sustain count is very low, which is the first count, the voltage between the A and Y electrodes is decreased in the waveform, and in the case when the sustain count is higher than the first count, but is relatively low among all subfields, which is the second count, the voltage between the A and Y electrodes is increased in the waveform, and in the case when the sustain count is higher than the second count and is still relatively high among all subfields, which is the third count, the voltage between the X and Y electrodes is increased, the voltage between the A and Y electrodes is increased, and the interval time is created between the sustain period and reset period, or the last sustain pulse voltage is increased. In this way, by customizing and fixing the reset drive voltage waveform according to the sustain count in the subfield, an ideal reset discharge can be generated with certainty.

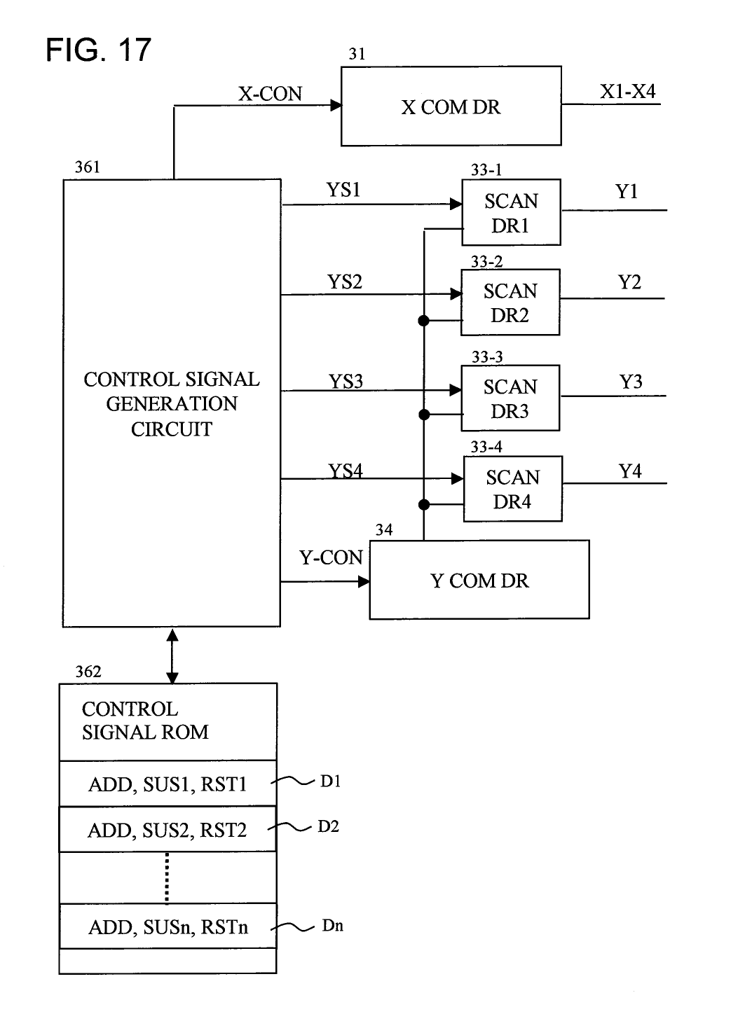

FIG. 17 is a diagram depicting the control circuit to drive the panel, the Y electrode drive circuit and the X electrode drive circuit according to the present embodiment. The Y electrode drive circuit 32 shown in FIG. 3 has a scanning drive circuit 33 and a Y side common drive circuit 34, and the X electrode drive circuit 30 has an X side common drive circuit 31, and the control circuit 36 supplies control signals to these drive circuits.

In FIG. 17, the scanning drive circuit 33 is comprised of scanning drive circuits 33-1 to 33-4, which applies scan pulses to each Y electrode Y1 to Y4 respectively. The Y side common drive circuit 34 is commonly disposed for the plurality of Y electrodes Y1 to Y4, and a sustain drive voltage waveform and reset drive voltage waveform generated here are applied to each Y electrode via each scanning drive circuit.

The control circuit 36 is comprised of a control signal generation circuit 361 and a control signal ROM 362. The control signal ROM 362 stores control data Dl to Dn corresponding to a plurality of types of subfields. Each control data D1 to Dn is configured by address control data ADD, sustain control data SUS1 to SUSn, and reset control data RST1 to RSTn. Here characteristically the control data D1 to Dn corresponding to the plurality of types of subfields have reset control data RST1 to RSTn corresponding to fixed sustain control data SUS1 to SUSn respectively. Each of the sustain control data SUS1 to SUSn has a different number of repeat sustain pulses, and different waveforms of the specified sustain pulses. The reset control data corresponding to each sustain control data is a control data which can generate an ideal reset discharge according to the sustain drive voltage waveform.

The control signal generation circuit 361 performs control which read control data D1 to Dn having the sustain control data in each subfield for the panel drive control. If the selected control data is read, an ideal reset control data corresponding to the sustain drive voltage waveform is read. Therefore compared with the case of a reset drive voltage waveform and a sustain drive voltage waveform in a subfield that are not corresponded one-to-one, the capacity of the control data in the control signal ROM can be decreased.

The specific circuit diagram of each drive circuit in FIG. 17 is disclosed in Japanese Patent Application Laid-Open No. H9-97034 (disclosed on Apr. 8, 1997), and U.S. Pat. No. 5,654,728, for example. The drive circuits disclosed in these patent publications are incorporated in the present description by reference.

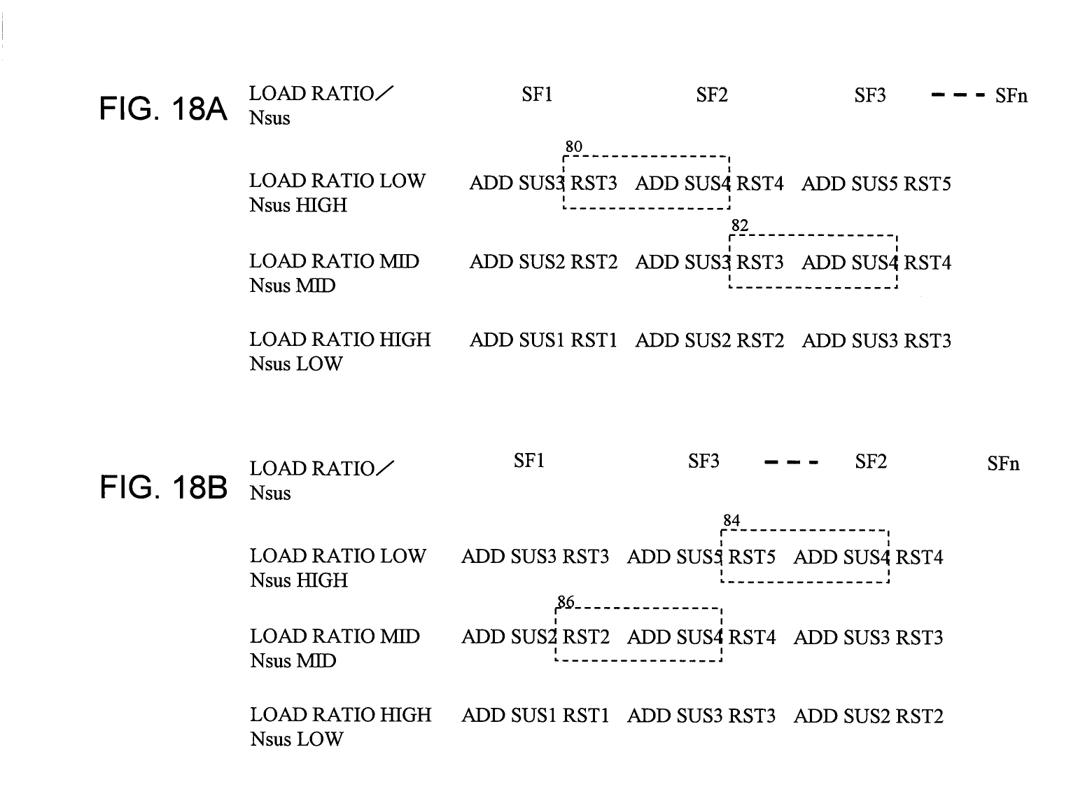

FIG. 18 shows the relationship between the display load ratio and control data of the subfield according to the present embodiment. FIG. 18 shows two types of arrangement examples, (A) and (B), of the subfields SF1, SF2, SF3 . . . SFn, in which emission brightness sequentially increases. In each example (A) and (B), examples of the control data of subfields of which display load ratio is small, medium and large respectively are described. It is assumed that the brightness ratio in the subfields SF1, SF2, and SF3 is 1:2:4, and the brightness ratio in the sustain control data SUS1, 2, 3, 4, and 5 is 1:2:4:8:16. And it is assumed that when the display load ratio is small, the sustain discharge count Nsus in the entire field is controlled to be the maximum, and when the display load ratio is mid or large, the sustain discharge count Nsus is controlled to be mid or the minimum.

According to the present embodiment, the drive control data of each subfield is configured by address control data ADD, sustain control data SUSm, and reset control data RSTm (m=1, 2, . . . n). In other words, the sustain control data SUSm is set corresponding to the brightness to be emitted, and reset control data RSTm corresponding to this sustain control data SUSm is set. Therefore if the emission brightness to be generated in each subfield is decided, control data of a subfield corresponding to this emission brightness can simply be selected and read from the ROM in the display control.

In FIG. 18A, the subfields are arranged in the sequence of SF1, SF2 and SF3. If the display load ratio is mid (Nsus is also mid), then sustain control data SUS 2, 3 and 4 are selected for the subfields SF1 to 3 respectively. If the display load ratio is the minimum (Nsus is maximum), or if the display load rate is the maximum (Nsus is maximum), the sustain control data SUS3, 4 and 5 or SUS1, 2 and 3 is selected for the subfields SF1 to 3 respectively. In FIG. 18, the broken line indicates the case when the control data is configured in the sequence of reset control data, address control data and sustain control data. The control data in broken lines 80 and 82 have the same reset control data RST3 for the same sustain control data SUS4. This is because the subfields are arranged in the sequence of SF1, SF2 and SF3.

In FIG. 18B, the subfields are arranged in the sequence of SF1, SF3 and SF2. The relationships of the display load rate minimum, mid or maximum, and sustain control data SUSm selected in each subfield SF1, SF2 and SF3 are the same as FIG. 18A. If the subfields are arranged in the sequence of SF1, SF3 and SF2 like this, the control data in broken lines 84 and 86 have different control data RST5 or RST2, for a same sustain control data SUS4. In this way, even if the subfields are controlled to be the same brightness, control data of the subfield differs, and drive control becomes complicated, or control data volume increases.

As mentioned above, according to the present embodiment, the reset control is selected according to the sustain control, so if a same sustain drive control (e.g. SUS4) is selected in different subfields SF2 and SF3, the same reset control (e.g. RST4) is selected. Hence the drive control of the subfield is simplified, or the control data volume is decreased.

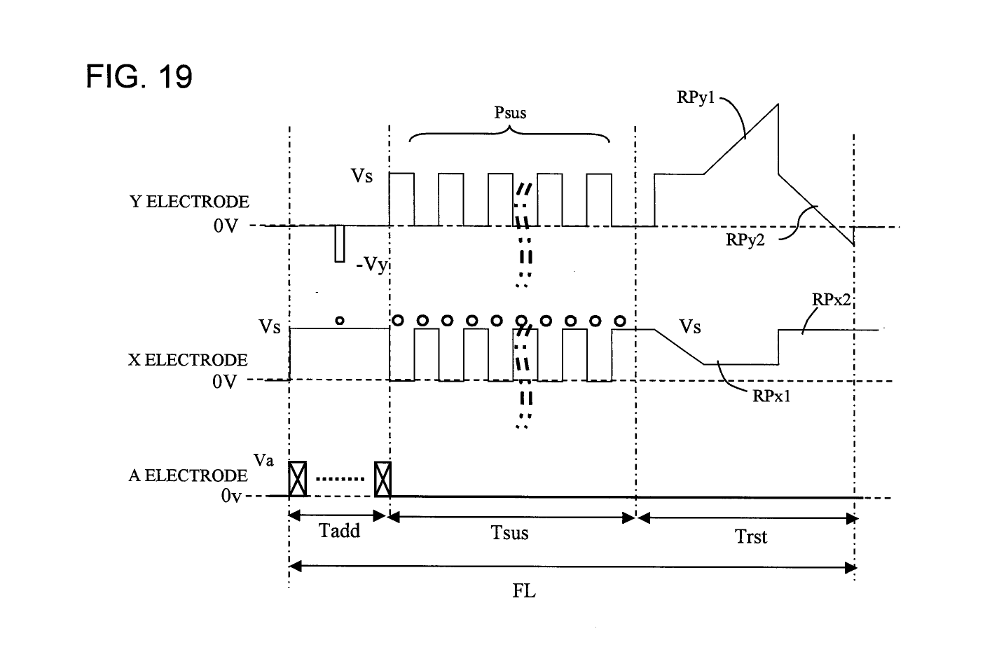

FIG. 19 is a diagram depicting an example of another drive voltage waveform according to the present embodiment. The drive voltage waveforms shown in FIG. 5 and FIG. 9 to FIG. 16 have pulse waveforms in which the sustain pulse oscillates between the positive voltage Vs and negative voltage −Vs with ground (0V) at the center. Whereas the drive voltage waveform in FIG. 18 has a pulse waveform in which sustain pulse Psus oscillates between ground (0V) and the positive voltage Vs. Corresponding to this, the first reset pulse RPx1 and the second reset pulse RPx2 of the X electrodes during reset are both positive voltages, not negative power supply voltages. Only the second reset pulse RPy2 of the Y electrode and the scan pulse −Vy are negative voltage pulses. In this drive voltage waveform as well, the basic countermeasures (A-1), (B-1) and (C-1) and fine is adjustments (A-2) and (B-2), equivalent to those mentioned above, can be applied.

What is claimed is:

1. A plasma display device, comprising:
a display panel having a plurality of first and second display electrodes and a plurality of address electrodes crossing the first and second display electrodes;
an electrode drive circuit which drives the first and second display electrodes and address electrodes; and
a drive control circuit which controls the electrode drive circuit, wherein
the drive control circuit performs an address drive control for selectively turning ON cells in each subfield, sustain drive control for generating sustain discharge in the ON cells, and reset drive control for resetting charges on the electrodes by applying slope pulse voltage on the first display electrodes, and
in the reset drive control in a first subfield in which a sustain discharge count is a first count, the drive control circuit sets a voltage between the first and second electrodes higher, or sets a voltage between the first and address electrodes lower, than a second subfield of which the sustain discharge count is a second count, which is higher than the first count.

2. The plasma display device according to claim 1, wherein in the reset drive control for a third subfield, of which the sustain discharge count is a third count, which is higher than the second count, the drive control circuit sets the voltage between the first and second electrodes higher, or sets the voltage between the first and address electrodes higher, than the second subfield.

3. The plasma display device according to claim 1, wherein in a third subfield of which the sustain discharge count is a third count, which is higher than the second count, the drive control circuit sets time between end of the sustain drive control and start of reset drive control, to be longer than the second subfield.

4. The plasma display device according to claim 1, wherein in the reset drive control for a third subfield of which the sustain discharge count is a third count, which is higher than the second count, the drive control circuit sets the voltage of the last sustain pulse higher than the second subfield.

5. The plasma display device according to claim 1, wherein in the reset drive control for the first subfield, when the last sustain pulse is a first voltage, the drive control circuit sets the voltage between the first and address electrodes higher, or the voltage between the first and second electrodes lower than those in a case of the last sustain pulse being a second voltage, which is lower than the first voltage.

6. The plasma display device according to claim 1, wherein in the reset drive control for the second subfield, when the last sustain pulse is a first voltage, the drive control circuit sets the voltage between the first and address electrodes higher, or the voltage between the first and second electrodes lower than those in a case of the last sustain pulse being a second voltage, which is lower than the first voltage.

7. A plasma display device, comprising:
a display panel having a plurality of first and second display electrodes and a plurality of address electrodes crossing the first and second display electrodes;
an electric drive circuit which drives the first and second display electrodes and address electrodes; and
a drive control circuit which controls the electrode drive circuit, wherein
the drive control circuit performs an address drive control for selectively turning cells ON in each subfield, sustain drive control for generating a sustain discharge in the ON cells, and reset drive control for resetting charges on the electrodes by applying slope pulse voltage on the first display electrodes, and
in the reset drive control for a third subfield in which a sustain discharge count is a third count, the drive control circuit sets a voltage between the first and second electrodes higher, or sets a voltage between the first and second electrodes higher than a second subfield of which the sustain discharge count is a second count, which is lower than the third count.

8. A plasma display device, comprising:
a display panel having a plurality of first and second display electrodes and a plurality of address electrodes crossing the first and second display electrodes;
an electrode drive circuit which drives the first and second display electrodes and address electrodes; and
a drive control circuit which controls the electrode drive circuit, wherein
the drive control circuit performs an address drive control for selectively turning cells ON in each subfield, sustain drive control for generating sustain discharge in the ON cells, and reset drive control for resetting charges on the electrodes by applying slope pulse voltage on the first display electrodes, and
in a third subfield in which a sustain discharge count is a third count, the drive control circuit performs reset drive control to set time between end of the sustain drive control and start of reset drive control to be longer than a second subfield of which the sustain discharge count is a second count, which is lower than the third count.

9. A plasma display device, comprising:
a display panel having a plurality of first and second display electrodes and a plurality of address electrodes crossing the first and second display electrodes;
an electrode drive circuit which drives the first and second display electrodes and address electrodes; and
a drive control circuit which control the electrode drive circuit, wherein
the drive control circuit performs an address drive control for selectively turning cells ON in each subfield, sustain drive control for generating sustain discharge in the ON cells, and reset drive control for resetting charges on the electrodes by applying slope pulse voltage on the first display electrodes, and
in a third subfield in which a sustain discharge count is a third count, the drive control circuit sets the voltage of the last sustain pulse higher than a second subfield of which the sustain discharge count is a second count, which is lower than the third count.

10. A plasma display device, comprising:
a display panel having a plurality of first and second display electrodes and a plurality of address electrodes crossing the first and second display electrodes;
an electrode drive circuit which drives the first and second display electrodes and address electrodes; and
a drive control circuit which controls the electrode drive circuit, wherein
the drive control circuit performs an address drive control for selectively turning cells ON in each subfield, sustain drive control for generating sustain discharge in the ON cells, and reset drive control for resetting charges on the electrodes by applying slope pulse voltage on the first display electrodes,
the drive control circuit further comprises a control data ROM which stores a plurality of subfield drive control data having data of the address drive control, sustain drive control and reset drive control which corresponds to the sustain drive control, for each of a plurality of types of sustain drive control, and
the drive control circuit performs the subfield drive control based on subfield drive control data which has sustain drive control corresponding to an emission brightness of each subfield.

11. The plasma display device according to claim 10, wherein the drive control circuit performs drive control of different subfields according to a display load ratio, based on the same subfield drive control data.

12. The plasma display device according to claim 1, wherein in the reset drive control, the drive control circuit performs a first reset drive which applies a positive polarity slope pulse to the first electrodes while driving the second electrodes to a first voltage, and a second reset drive which applies a negative polarity slope pulse to the first electrodes while driving the second electrodes to a second voltage.
